(19) United States
(12) Patent Application Publication
(10) Pub. No.: US 2005/0133942 A1
(43) Pub. Date: Jun. 23, 2005

(54) Cartridge humidifier

(75) Inventor: Daniel E. Schuld, Inverness, IL (US)

Correspondence Address: GREER, BURNS & CRAIN, LTD.;Suite 2500, 300 South Wacker Drive, Chicago, IL, 60606, US

(73) Assignee: RPS Products, Inc.

(21) Appl. No.: 10/741,109

(22) Filed: Dec. 19, 2003

(51) Int. Cl. B01F 3/04

(52) U.S. Cl. 261/106; 261/107

(57) ABSTRACT

A cartridge humidifier has a tubular, air permeable, water retentive or absorbent evaporator pad, a tubular, air permeable, generally rigid support for supporting the pad and for imparting strength and shape to the pad, and a tubular water distributor attached to the support for distributing water uniformly to the pad and for accommodating or inducing air flow transversely through the pad into the hollow core of the pad and support and for discharging moistened air axially through the hollow core of the distributor. The cartridge humidifier may also have one or more water reservoirs, a pump for transferring water form a reservoir to the distributor and thence to the evaporator pad, and a fan for inducing air flow transversely through the pad and axially out to the ambient through the hollow core.

### FIELD OF THE INVENTION

The present invention relates to humidifiers, especially a cartridge humidifier that may be installed in a furnace or heating duct or that may comprise a stand-alone humidifier having a designer appearance.

### BACKGROUND OF THE INVENTION

Humidifiers and the benefits derived from their use are widely known. Humidifiers are conventionally comprised of a liquid absorbent evaporator pad, a liquid distribution system for delivering a liquid, usually water, to the pad, and an air distribution system for causing air and/or other gases to pass through the moist pad to add moisture to the air or gas. Humidifiers may be installed in furnaces and heating ducts for adding moisture to dry heated air emanating from a hot air furnace or other air circulating system. Humidifiers are also available as stand alone or freestanding units for adding moisture to the air in an enclosed space, such as one or more rooms in a home or office.

Stand-alone units are customarily comprised of a louvered cabinet containing a liquid absorbent pad, a reservoir for holding liquid, a pump for circulating liquid from the reservoir to the pad, and a fan for drawing ambient air through the pad and distributing the moistened air back into the room. In some instances, a portion of the pad may be immersed in the liquid reservoir in order to moisten the pad in whole or in part by the wicking action of the absorbent material. In many cases, the liquid circulating pump is omitted and reliance is placed solely on the wicking action to moisten the pad, in which event, the pad is effective only over a very limited vertical height.

Due to the fact that air born dust and debris is removed from the air in its passage through the absorbent pad, pads become dirty and must periodically be cleaned or replaced. Also, deposits in the moistening liquid, such as calcium and lime in water, are removed from the liquid, by virtue of evaporation of the liquid, and are deposited on the absorbent pad, necessitating in most cases periodic replacement of the pad.

### SUMMARY OF THE INVENTION

The present invention provides, in a first embodiment, an improved and readily replaceable cartridge humidifier for general application and, in a second embodiment, an improved stand-alone cartridge humidifier.

The first embodiment of the cartridge humidifier of the invention is comprised of an elongate tubular evaporator pad of liquid absorbent and air permeable material, an elongate tubular generally rigid air permeable support for the evaporator pad that is generally co-extensive with the pad for supporting the pad throughout substantially its entire length, and a tubular liquid distributor attached to one end of the support for distributing liquid to the pad while accommodating passage of air transversely through the pad and support and discharge of air axially from the interior of the pad and support.

The second embodiment of the cartridge humidifier of the invention is comprised of the above described first embodiment mounted in an upright position with a distributor at the upper end of the support, a base at the lower end of the support containing a liquid reservoir, means for supplying liquid to the reservoir, means for transferring liquid from the reservoir to the distributor, and means for drawing air through the pad and support, from the exterior to the interior of the pad and support and for discharging moistened air axially through the distributor. The means for supplying liquid to the reservoir preferably comprises at lease one container mounted on the base contiguous to at least a portion of the evaporator pad and in liquid communication with the reservoir.

Both embodiments of the invention are practical, economical and easy to use and maintain. The first embodiment is preferably made of degradable/recyclable materials and is therefore disposable and readily replaceable at nominal cost. The use of an elongate, fully supported, tubular evaporator pad facilitates development of humidifiers having a tall thin profile and requiring minimal floor space for a selected amount of moisture output.

These and other advantages of the invention will become apparent to those of reasonable skill in the art from the following detailed description, as considered in conjunction with the accompanying drawings.

### BRIEF DESCRIPTION OF THE DRAWINGS

FIG. 1 is a perspective view of the first embodiment of the cartridge humidifier of the invention;

FIG. 2 is a perspective view of the support member employed in the first embodiment of the invention;

FIG. 3 is a perspective view of the second embodiment of the cartridge humidifier of the invention;

FIG. 4 is an exploded perspective view of the second embodiment; and

FIG. 5 is a schematic illustration of the liquid and air circulation systems employed in the second embodiment of the invention.

### DETAILED DESCRIPTION OF PREFERRED EMBODIMENTS

The following is a description of certain embodiments of the invention presently deemed by the inventor to be the best mode of carrying out the invention.

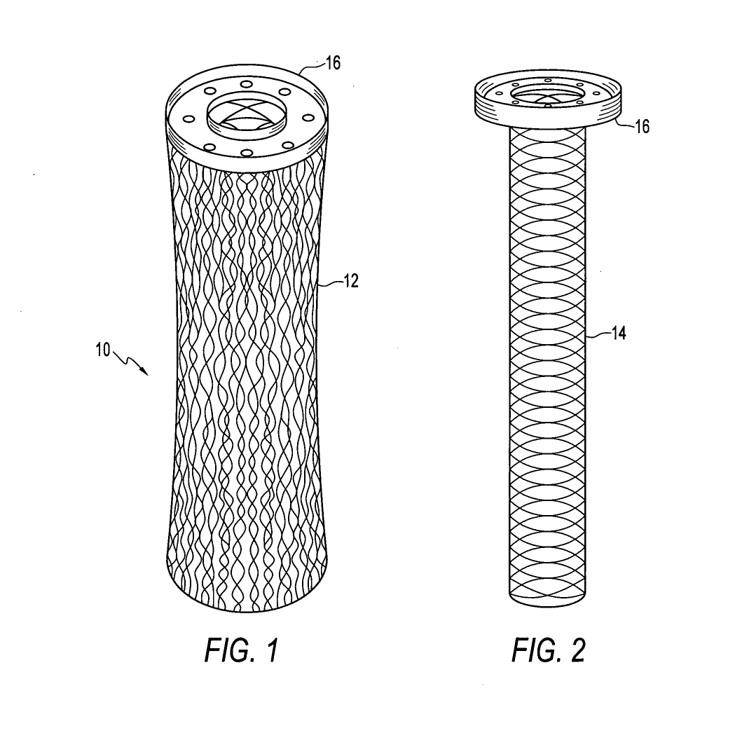

Referring to FIGS. 1 and 2, the elemental humidifier of the invention is a cartridge 10 comprised of an elongate tubular evaporator pad 12, a tubular generally rigid elongate support 14 for the pad, and a tubular liquid distributor 16 attached to one end of the support 14. The cartridge 10 preferably has a tall, slim profile, for example, sixteen to eighteen inches tall and four to six inches in diameter.

The evaporator pad 12 is formed of any of the air permeable, liquid absorbent or liquid retentive materials conventionally or typically used in evaporative humidifiers, for example, multiple plies or layers of paper, film and/or foil that have been slit and expanded to define a tortuous path for airflow transversely through the pad, thereby to insure thorough contact of air with liquid absorbed by or retained on the pad. The term “absorbent pad” is intended to include metal and plastic foils and films that have been coated or otherwise treated to encourage liquid to cling to the foil or film surface, as well as truly absorbent materials such as paper, foam and sponge.

The support 14 is made of a generally rigid material, such as metal or plastic, that has been fabricated so as to be air permeable. Suitable materials include slit and expanded metal or plastic as illustrated in FIG. 2, perforated metal or plastic, and sturdy screens. The support is generally coextensive with the pad and imparts the desired strength, shape and rigidity to the pad.

The cross-sectional configuration of the support, pad and distributor may be round, square, rectangular or polygonal, as long as they are tubular, i.e., with a hollow core and a peripheral wall. The support 14 may be located on the interior surface or the exterior surface of the pad 12 or may be embedded within the pad, e.g., between adjacent plies of the pad, to impart shape and strength to the pad.

The distributor 16 is preferably annular and of the same size and configuration as the support and pad, so as to accommodate air flow into and through the hollow core of the pad and support and to distribute humidifying liquid uniformly onto and throughout the evaporator pad. The annulus comprising the distributor is preferably cup shaped to hold a quantity of liquid and is provided in its base wall with a plurality of spaced holes for feeding liquid uniformly to the pad.

The cartridge 10 thus comprises a unitary assembly providing an economical and highly efficient humidifier. The materials of construction are preferably degradable and/or recyclable so the cartridge can be conveniently disposed of and economically replaced.

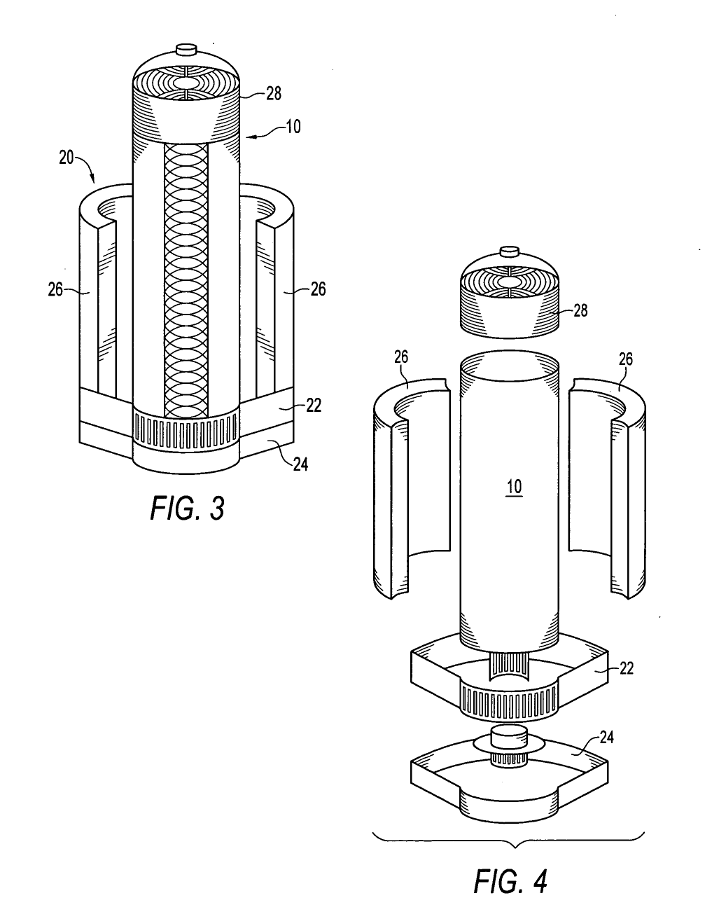

The cartridge 10 also comprises the platform for development of a stand-alone humidifier, such as the humidifier 20 illustrated in FIGS. 3-5. The humidifier 20 comprises a base 22 for mounting and supporting the cartridge 10 in an upright position with the liquid distributor 16 at its upper end. The support 14 is suitably attached at its lower end to the base 22. The base defines a liquid reservoir 24 into which the lower end of the pad 12 maybe inserted, and also provides support for one or more, suitably two, liquid containers 26 which are in fluid communication with reservoir 24. Alternatively, the base may collect water for discharge to drain. The liquid containers serve to keep the reservoir full of liquid in much the same way as a water cooler is supplied with bottled water.

For aesthetic purposes, the liquid container or containers 26 may be conformed at least in part to at least a portion of the cartridge 10, but in such fashion as not to obstruct airflow through major portions of the cartridge.

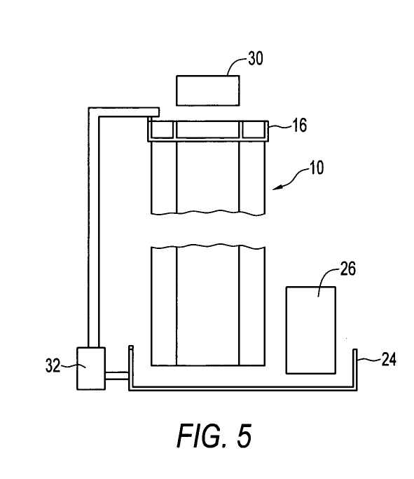

A fan housing and air distributor 28 is mounted on the upper end of the cartridge 10 and contains a fan 30 (illustrated schematically in FIG. 5) for drawing air through the pad 12 and into the interior of the cartridge and for exhausting humidified air axially through the upper end of the humidifier.

The humidifier 20 also includes a liquid distribution system, which is illustrated schematically in FIG. 5. As shown, the liquid container or containers 26 feed liquid, usually water, into the reservoir 24 and a pump 32, having its inlet connected to the reservoir 24 and its outlet connected to the distributor 16, circulates liquid from the reservoir to the distributor. The distributor distributes the liquid to the evaporator pad for descent by gravity through the pad to thoroughly moisten the pad, with any excess liquid being returned to the reservoir. The fan 30 draws air through the pad to add moisture to the air and then discharges the humidified air to the ambient atmosphere.

The humidifier 20 is compact, efficient and has a tall thin profile providing an aesthetically pleasing appearance and occupying minimal floor space.

The objects and advantages of the invention have therefore been shown to be attained in a convenient, economical, practical and facile manner.

While certain presently preferred embodiments of the invention have been herein illustrated and described, it is to be appreciated that modifications, rearrangements and changes may be made therein without departing from the scope of the invention as defined by the appended claims.

1. A cartridge humidifier comprising
an elongate tubular evaporator pad of liquid absorbent and air permeable material,
an elongate tubular generally rigid air permeable support for said evaporator pad, said support being generally coextensive with said pad for supporting said pad throughout substantially its entire length and accommodating flow of air transversely through the pad and support and axially within the interior of the pad and support, and
a liquid distributor attached to said support at one end thereof for distributing liquid to said pad.

2. A humidifier as set forth in claim 1, wherein said distributor is an annulus and has spaced holes therein for distributing liquid substantially uniformly to said pad.

3. A humidifier as set forth in claim 1, wherein said support engages the interior surface of said pad.

4. A humidifier as set forth in claim 1, wherein said support engages the exterior surface of said pad.

5. A humidifier as set forth in clams 1, wherein said support is embedded within said pad.

6. A humidifier as set forth in claim 1, wherein said support is formed of a slit and expanded material.

7. A humidifier as set forth in claim 1, wherein said pad is formed of a liquid wicking material.

8. A humidifier as set forth in claim 1, wherein said pad is formed of multiple layers of slit and expanded liquid absorbent material.

9. A cartridge humidifier comprising
an elongate upright tubular evaporator pad of liquid absorbent and air permeable material, said pad having an upper end and a lower end,
an elongate tubular generally rigid air permeable support for said evaporator pad, said support having an upper end and a lower end and being generally coextensive with said pad for supporting said pad throughout substantially its entire length,
a tubular liquid distributor attached to said support at the upper end thereof for distributing liquid to said pad, and
a base at the lower end of said support.

10. A humidifier as set forth in claim 9, further comprising a liquid reservoir in said base, means for supplying liquid to said reservoir, means for transferring liquid from said reservoir to said distributor, and means for drawing air transversely through said pad and support and for drawing air axially through the interior of said pad, said support and said distributor.

11. A humidifier as set forth in claim 10, wherein said means for supplying liquid to said reservoir comprises at least one container at least partly conformed to said pad and support.

12. A humidifier as set forth in claim 9, wherein said pad is formed of a liquid wicking material and said base comprises a liquid reservoir for wicking liquid into at least the lower regions of said pad.

13. A humidifier as set forth in claim 9, wherein said pad is formed of multiple layers of slit and expanded liquid absorbent material and said support is formed of a slit and expanded generally rigid material.

14. A humidifier as set forth in claim 9, wherein said support engages the interior surface of said pad.

15. A humidifier as set froth in claim 9, wherein said support engages the exterior surface of said pad.

16. A humidifier as set forth in claim 9, wherein said support is embedded within said pad.

17. A cartridge humidifier comprising;
an elongate upright tubular evaporator pad of liquid absorbent and air permeable material, said pad having an upper end and a lower end,
an elongate tubular generally rigid air permeable support for said evaporator pad, said support having an upper end and a lower end and being generally coextensive with said pad for supporting said pad throughout substantially its entire length,
a tubular liquid distributor attached to said support at the upper end thereof for distributing liquid to said pad, and
a base at the lower end of said support for mounting said pad and said support in upright position, said base containing a reservoir for receiving liquid.

18. A humidifier as set forth in claim 17, including means for supplying liquid to said reservoir, means for transferring liquid from said reservoir to said distributor, and means for drawing air transversely through said pad and support and for discharging air from the interior of said pad and support axially through said distributor.

19. A humidifier as set forth in claim 18, wherein said means for supplying liquid to said reservoir comprises at least one container mounted on said base in liquid communication with said reservoir.

20. A humidifier as set forth in claim 19, wherein said at least one container is at least partly conformed to said pad and support.
